(19) United States
(12) Patent Application Publication
(10) Pub. No.: US 2001/0051942 A1
(43) Pub. Date: Dec. 13, 2001

(54) Information retrieval user interface method

(76) Inventor: Paul Toth, Vancouver (CA)

Correspondence Address: Orange & Chari, Suite 4900, P.O. Box 190, 66 Wellington Street West, Toronto, ON, M5K 1H6, CA

(21) Appl. No.: 09/877,200

(22) Filed: Jun. 11, 2001

Related U.S. Application Data
(60) Provisional application No. 60/210,974, filed on Jun. 12, 2000.

(51) Int. Cl. G06F 17/30

(52) U.S. Cl. 707/3; 707/5

(57) ABSTRACT

This invention provides an information retrieval user interface wherein the method provided to the user for searching electronic collections of records or objects that are identified via the assignment of attributes and corresponding values is both powerful in its multi-criteria search capabilities and easy to learn and use relative to existing interfaces. The user is provided with the ability to enter search criteria by selecting from the list of available attributes and entering a corresponding value for the selected attribute. The resulting answer set corresponds to the records returned based on the sequence of all previous user executed actions. The user can continue selecting attribute and value criteria and performing actions thereby altering the answer set until the desired result is achieved.

### FIELD OF THE INVENTION

The present invention relates to an information retrieval system. More particularly, it relates to a user interface method for retrieving information from an electronic collection of records or objects.

### BACKGROUND OF THE INVENTION

Information retrieval deals with the representation, storage, organization of, and access to information items. Ideally, the representation and organization of the information items should provide a user with easy access to the information of interest. To that end, knowledge management systems play a important role in retrieving information, especially in instances where dispersed business enterprises require a systematic process of acquiring, finding, selecting, storing, sharing, organizing and presenting information. Thus, knowledge management systems provide the ability to manage increasingly complex information and also allow users to search for, and to receive relevant information using familiar computing devices from enterprise-wide databases.

Generally, interaction with the databases is afforded by information retrieval user interfaces on the devices. These information retrieval user interfaces typically fall into three main categories: keyword text search interfaces, hierarchical tree interfaces, and multi-criteria Boolean search interfaces. Keyword text search interfaces often return answer sets to the user that contain many irrelevant answers. This results in significant amounts of time searching for items that may or may not be catalogued in the information system. For example, given a fill description of the desired information, a user must first translate this information into a query which can be processed by the system. In its most common form, this translation yields a set of keywords which summarizes the description of the user information needs. Given the user query, the key goal of an information retrieval system is to retrieve information which might be useful or relevant to the user while consuming the minimum amount of time that is acceptable to that user.

Hierarchical tree interfaces are an attempt to provide a more efficient way for the user to locate the desired results substantially faster than keyword text search interfaces. However, two drawbacks exist with this approach, the first being that stored items often do not fall into only a single category nor do stored items always fit well in any of the categories. This often means that the user does not know which branch of the tree to search within, and often, the branches chosen must be searched down several levels before it becomes obvious that the desired item is not stored within that particular branch. Once again, this may result in a significant amount of time. The second drawback is inherent in the method of hierarchical storage, that is, if the number of stored items is substantially large, the system must either have a potentially overwhelming number of branching categories or the number of items at the end of a branch must be substantially large. As will be appreciated by those of skill in the art, the greater the number of branching categories, the greater the time required to search to reach the terminal branch, and the items stored within that branch. Similarly, if there is a substantial number of items stored at the terminal branch of a more simple set of branches, then the user is forced to scan through the substantial number of items to determine whether the search actually returned a desired answer.

Another attempt to better classify items is exemplified by Boolean search interfaces. These interfaces use fields reserved for specific characteristics, such as height, price, material, and although this approach functions considerably well for single criteria searches, multi- criteria searches become appreciably difficult for the average user. For example, a single criteria search (Price=$1000) is considerably more simple than a complex search (Price=$1000, Material=Metal, Material=Glass and Country of Origin is not China). One of the drawbacks of this approach is that most people find it difficult to understand the Boolean logic behind a multi-criteria search using multiple ANDs and ORs. Often times, the results returned do not contain matching answers, so that the user does not receive feedback as to which part of the search criteria was too stringent. Also, the results returned might contain too many answers such that the user does not know how to better refine the search. As with the two search interfaces described above, Boolean searches may require a considerable amount of time in order to yield the desired results.

Multi-criteria single step query execution, such as a Boolean search, may be difficult to master for an average user and does not provide feedback since the answer set is displayed only after all criteria are applied.

Accordingly, it is an object of the present invention to mitigate at least one of the above disadvantages.

### SUMMARY OF THE INVENTION

In one of its aspects, the present invention provides an information retrieval user interface method for searching electronic collections of records or objects, thus facilitating multi-criteria search capabilities. The method includes the steps of: associating each record or object with at least one attribute and a corresponding value and defining a search criteria associated with the record or object. Other steps include executing a plurality of search actions in accordance with a search criteria, in which search actions are executed progressively to produce a corresponding answer set subsequent to each search action. Preferably each search has a different search criteria in order to refine the previous answer set. The method also includes the steps of displaying the answer set upon completion of a search action and recording the plurality of search actions associated with each answer set.

In the preferred embodiment multiple step single criteria query execution is facilitated with user input and feedback upon completion of a step. Typically, the result of the culmination of all single step criteria is potentially the same as what would have achieved via one multi-criteria step.

In another of its aspects, the present invention includes a user interface having a selectable list of attributes, an area to enter a value or a range of values, a selector to select one of a plurality of search actions, a viewer to view a resulting answer set of records or objects and a display to view the current sequence of search steps applied to achieve a current answer set.

### BRIEF DESCRIPTION OF THE DRAWINGS

These and other features of the preferred embodiments of the invention will become more apparent in the following detailed description in which reference is made to the appended drawings wherein:

FIG. 1 shows a system for retrieving information for searching electronic collections of records or objects, in a preferred embodiment;

FIG. 2 shows a screen shot of a user interface for implementation of the present invention, in a preferred embodiment;

FIG. 3 shows a flowchart corresponding to a start action;

FIG. 4 shows a flowchart corresponding to an add action;

FIG. 5 shows a flowchart corresponding to a select action;

FIG. 6 shows a flowchart corresponding to a remove action;

FIG. 7 shows a flowchart corresponding to an undo action;

FIG. 8 shows a screen shot of a web browser user interface displaying a general search screen;

FIG. 9 shows a screen shot of a web browser user interface displaying a result from a search action; and

FIG. 10 shows a screen shot of a web browser user interface displaying a history of the search actions.

### DESCRIPTION OF THE PREFERRED EMBODIMENTS

The preferred embodiment illustrated facilitates the ability to breakdown complex searches into, single criteria search steps, in which an answer set is displayed upon completion of a step. In the preferred embodiment, a user retrieves information through use of the interim feedback provided upon completion of a step and allows the user to better navigate through the search by narrowing or expanding the criteria so that the answer set matches the targeted result. For a non-technical user, the user interface enables the targeted result to be achieved without formulation of complex instruction sets.

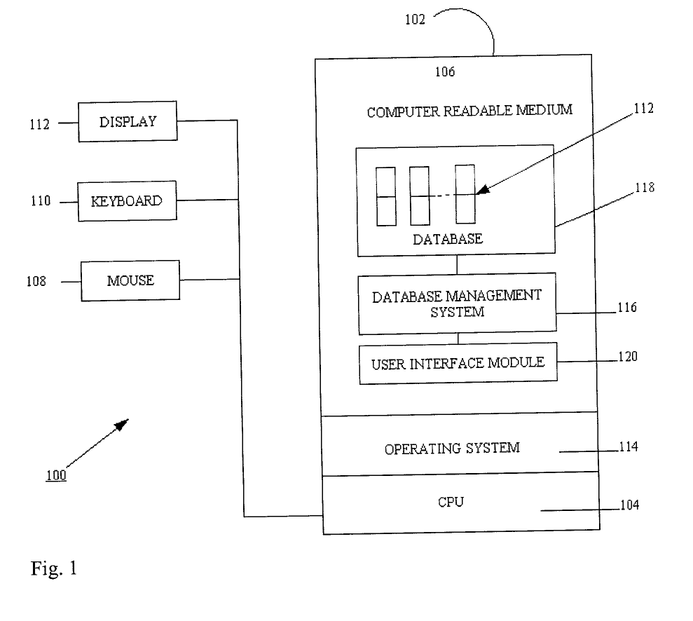

Reference is first made to FIG. 1, which shows an overview of a system for retrieving information, shown generally by numeral 100, in a preferred embodiment. A computer 102 includes a processor 104, a computer readable medium 106 including ROM, flash memory, non-volatile RAM, magnetic disk, optical disk, IC memory card, magnetic tape. The computer also includes input and output devices such as a mouse 108, a keyboard 110 and a display 112. The computer 102 executes a conventional operating system 114, such as Microsoft Windows 200® or UNIX. Alternatively, the computer 102 may be a handheld computing device with a handheld operating system such as EPOC, Palm®OS or Pocket PC®OS. Such handheld devices may include personal digital assistants (PDAs), pagers, cellphones and other wireless information devices.

The computer readable medium 106 includes a computer readable product having a database management system 116 coupled to a database 118, and a user interface module 120. The computer readable medium 106 stores sequences of instructions or executable programs for effecting the plurality of search actions and other processes. The user interface module 120 may be implemented as part of a variety of different software products executable by computer 102, such as database management system 116, a spreadsheet, word processor, scientific analysis tools, or the like.

The user interface module 120 is given access to a plurality of records 122, which are associated with a plurality of attributes and each attribute has a corresponding value. The records 122 are stored in the database 118 via the database management system 116. The user interface module 120 interfaces with the database management system 116 to receive user queries, to retrieve records 122 in database 118 and to display results to such queries on display 112.

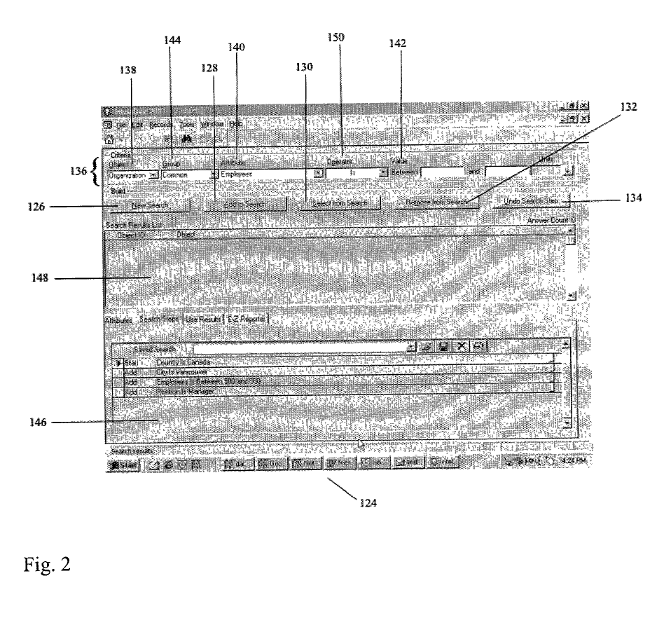

In order to describe the preferred embodiment in operation reference is now made to FIG. 2, which shows a screenshot of a user interface 124 for use in retrieving information. Typically, the user interface 124 generated by the module 120 is implemented via the display 112, and includes a set of control buttons that facilitates the search and retrieval of information by imparting a plurality of search actions to the database 118. The control buttons include a new search button 126 for starting a new search, an add button 128 for adding matching records or objects to an existing answer set, a select button 130 for selecting matching records or objects from an existing answer set. Also included within the set of control buttons is a remove button 132 for removing matching records or objects from an existing answer set and an undo button 134 for reversing the last search action performed by the user. These buttons are selectively enabled depending upon the state of the refine operation. As a way of interacting with the system 100 for input and control, the user typically uses the mouse 108 and the keyboard 110. However, other inputs and controls such as pointing devices, touch sensitive display screens and voice activation schemes including a voice recognition engine may be employed.

Queries are constructed via a search criteria area 136 in which an object 138, an attribute 140 and a corresponding attribute value 142 are chosen. Preferably, the system 100 may employ an attribute grouping criteria to identify a plurality of attributes with a common name or title 144. Also, the system 100 may optionally use a single entry field 142 for the user to specify single values or value ranges in their search value criteria or it may use two fields, one is used for single value criteria and the second when a range is specified. Attributes may include any of the following types but not limited to text, integers, real numbers, Boolean values, currency, dates, hyperlinks, images, sound, video, and the like. Similarly, the answer set may contain text, video, audio or any form of multimedia information or links to such information.

As each search action is executed, the action and search criteria may be recorded by the system 100 for later review by the user or for later execution. The sequence of search steps may be optionally saved by the user for future recall and execution. The sequential step list is displayed in an area 146, while the results from each step or multiple steps are displayed in a results area 148. In order to refine the search, operators such as “IS”, “IS NOT”, “IS SPECIFIED”, “WAS EVER” and “IS NOT SPECIFIED” may be specified by selecting an operator from a drop down list in an operator field 150.

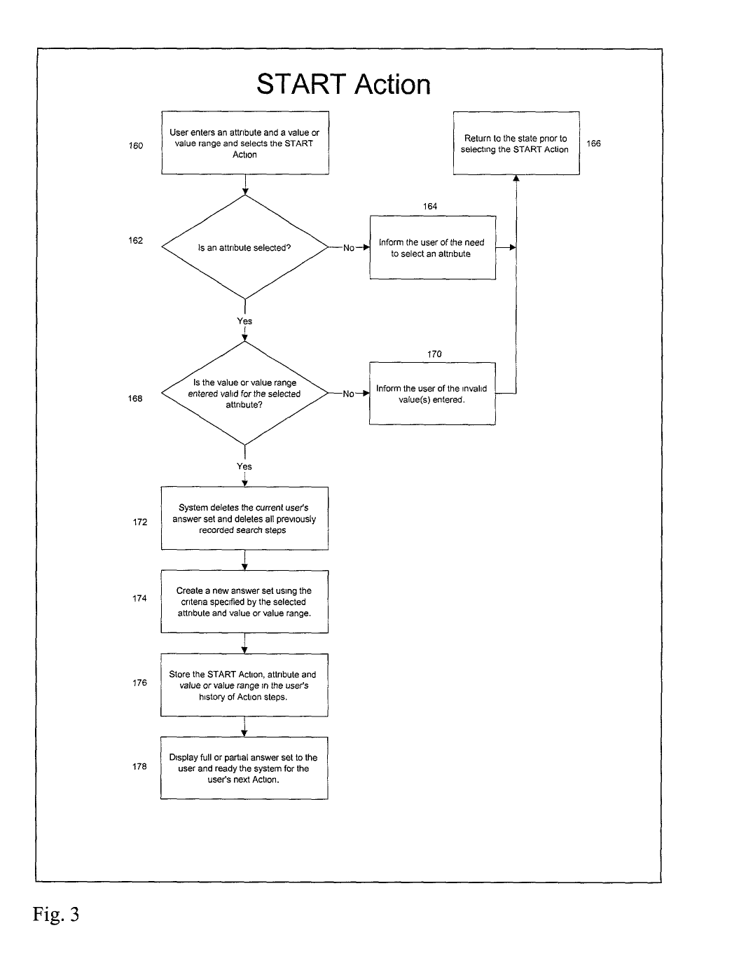

A sequence of steps for using a preferred embodiment of the present invention will now be described with reference to the flow charts in FIG. 3, 4, 5, 6 and and 7. In FIG. 3, the sequence starts with step 160 in which the user enters an attribute and a value of the object to be searched in fields 140, 142 respectively. This action may be facilitated by selecting an attribute or value from the respective pull down list. In step 162, a determination is made whether an attribute has been selected, if an attribute has not been selected then the user is instructed to do so in step 164 and is subsequently returned to step 166, the state prior to selecting the start action. However, if the attribute has been selected, the sequence proceeds to step 168 and another determination is made whether a value has been selected, and if no values are entered the user is returned to step 166. The attribute and value having been selected, the system 100 deletes any previous answer sets and any previously recorded search steps in step 172 and proceeds to step 174.

In step 174, the search action is then executed which adds to the empty answer set all corresponding records or objects 122 from the database 118 containing the assigned attribute and value as entered by the user. A new answer set is created in accordance with the search criteria specified by selected attribute and value. The search action, that is, the start action, and the search criteria, including the selected attribute and value, are recorded in the sequential list of steps as the first step of the new search, in step 176. The next step 178 displays the answer set or a portion of it in the search results area 148, and awaits the user's next action, For example, suppose the search criteria is as follows: Attribute=Condition and Value=Excellent, then the answer includes all records or objects where the Condition is equal to Excellent.

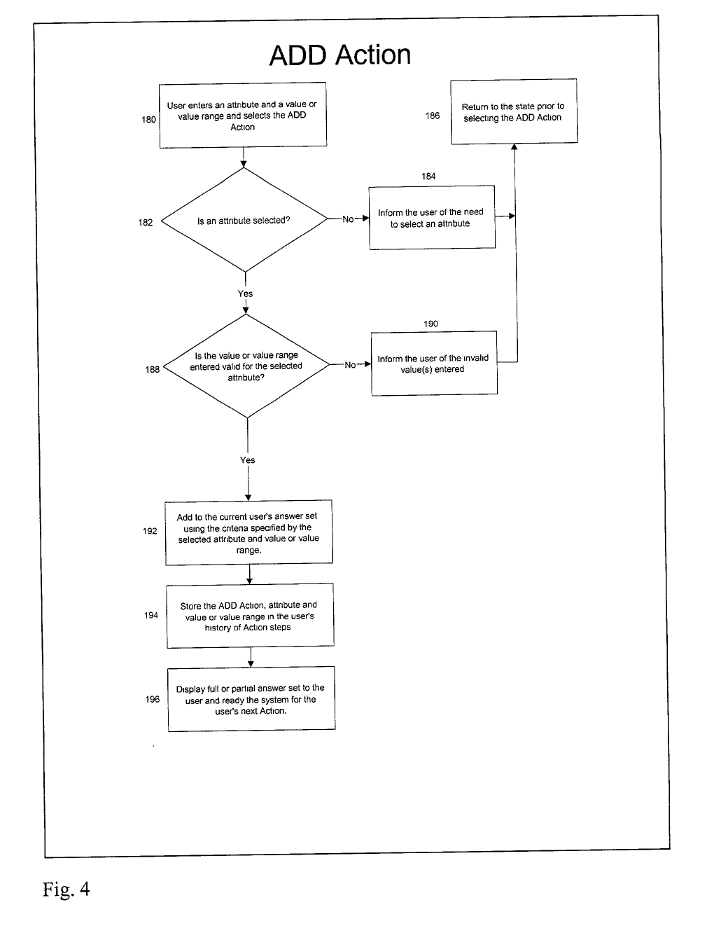

In FIG. 4, which shows a flow chart a sequence of steps for an add search action, this search action adds matching records or objects to the existing answer set for the user. The sequence starts with step 180 with the input of an attribute and a value or a value range by the user, and the add button 128 is enabled to effect the add action. Following step 180, a determination is made whenever an attribute has been selected in step 182. If an attribute has not been selected, the user is informed in step 184 and returned to a state prior to selecting the add action in step 186. However, if the attribute has been selected, the sequence proceeds to step 188 and a determination whether a corresponding attribute value has been selected. If a value corresponding to the attribute has not been selected, then the user is informed in step 190 and subsequently returned to step 186. However, the attribute and the value having been selected and valid, the search action is then executed which adds to the current answer set all corresponding records or objects containing the assigned attribute and value as entered by the user, in step 192. As described above in FIG. 3, the add search action, attributed value are recorded in step 194 and a new answer set is displayed in step 196.

The search action and search criteria are recorded in the sequential list of steps. For example, suppose the search criteria is as follows: Attribute=Condition and Value=Good and the Add action is selected, then the answer set includes all previous records or objects in addition to all records or objects where the Condition is equal to Good.

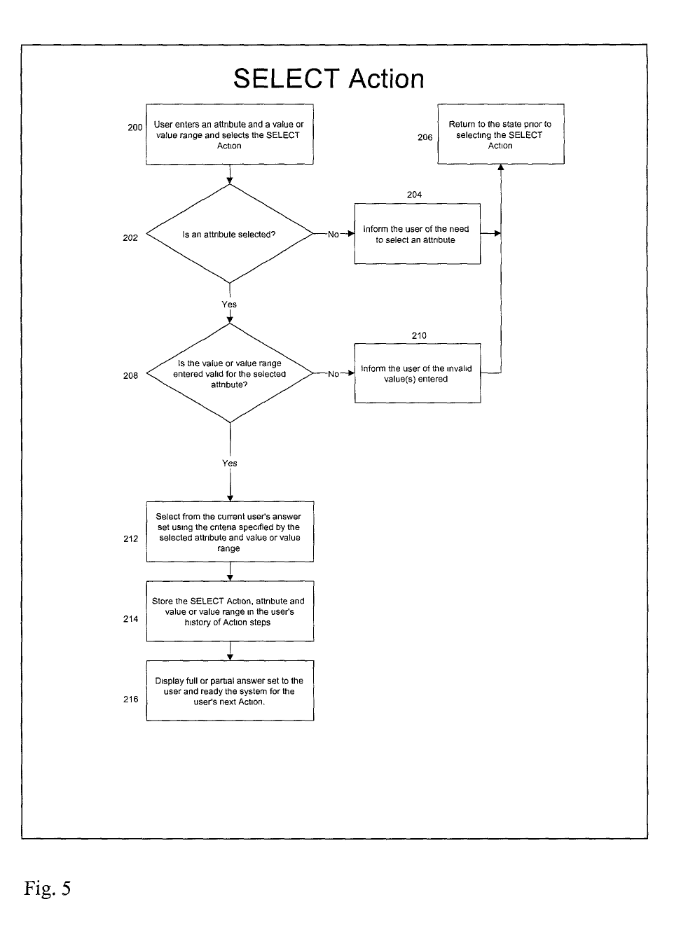

FIG. 5 shows a sequence of steps for a select search action, this search action selects matching records or objects from the existing answer set for the user. The sequence starts with step 200, in which the user enters an attribute and a value and selects the select action via the select button 136. Following step 200, a determination is made whenever an attribute has been selected in step 202. If an attribute has not been selected, the user is informed in step 204 and returned to a state prior to selecting the add action in step 206. However, if the attribute has been selected, the sequence proceeds to step 208 and a determination whether a corresponding attribute value has been selected. If a value corresponding to the attribute has not been selected, then the user is informed in step 210 and subsequently returned to step 206. However, the attribute and the value having been selected and valid, the search action is then executed which selects from the current answer set all corresponding records or objects containing the assigned attribute and value as entered by the user, in step 212. As described above in FIG. 3, the select search action, attributed value are recorded in step 214 and a new answer set is displayed in step 216. For example, suppose the search criteria is as follows: Attribute=Price and value=$500 to $800 and the Select action is chosen, then the answer set includes all records or objects found in the current answer set where the Price is between $500 and $800.

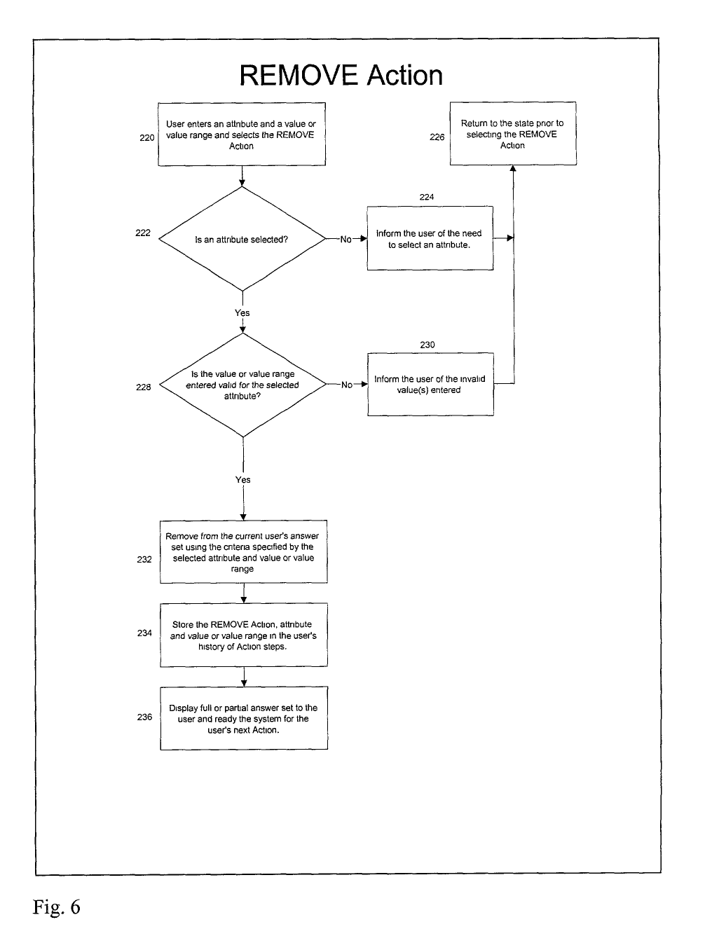

FIG. 6 shows a sequence of steps for a remove search action, His search action removes matching records or objects from the existing answer set for the user. The sequence starts with step 220, in which the user enters an attribute and a value and enables the remove button 132. Following step 220, a determination is made whenever an attribute has been selected in step 222. If an attribute has not been selected, the user is informed in step 224 and returned to a state prior to selecting the add action in step 226. However, if the attribute has been selected, the sequence proceeds to step 228 and a determination whether a corresponding attribute value has been selected. If a value corresponding to the attribute has not been selected, then the user is informed in step 230 and subsequently returned to step 226. However, the attribute and the value having been selected and valid, the search action is then executed which removes from the current answer set all corresponding records or objects containing the assigned attribute and value as entered by the user, in step 232. As described above in FIG. 3, the remove search action, attributed value are recorded in step 234 and a new answer set is displayed in step 236. For example, suppose the search criteria is as follows: Attribute=Material and Value=Silver and selects Remove action is chosen, then the answer set includes all records or objects found in the current answer set where the Material is not Silver.

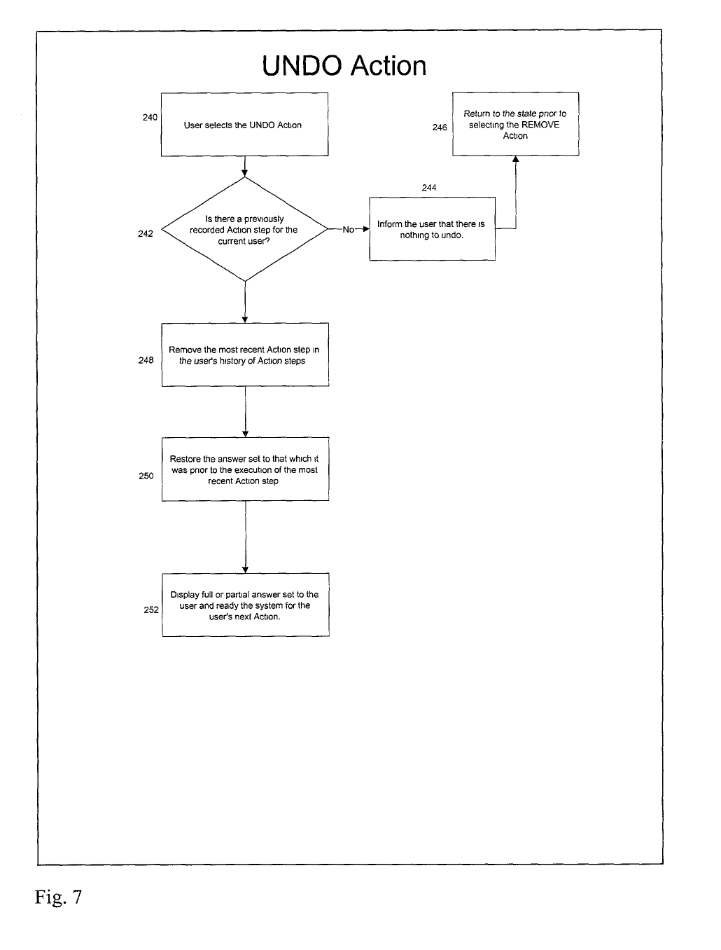

FIG. 7 shows a sequence of steps from an undo action, this search action undoes the previous search action. The sequence starts with step 240, in which the user selects the undo action via the undo button 134. In the next step 242, a determination is made by the system 100 whether there is a previously recorded action for the current user. If no previous actions exist, the user is informed in step 244 and returned to the state prior to selecting the undo action in step 246. However, should there be a previously recorded action step for the current user, the most recent action step in the user's history of steps is removed in step 248. The answer set prior to the execution of the most recent action step is restored in step 250. The last step 252 displays the answer set or a partial answer set and the system 100 awaits the users next action. For example, suppose the search criteria is as follows: User Selects Undo, then the answer set (following the logic of all previous examples listed herein) displays all records or objects found in the current answer set where the Condition is Good or Excellent and the Price is between $500 and $800.

The preferred embodiment of the present invention may be implemented with a number of variations. For example, the displayed answer set upon completion of a search action may be a portion of the actual answer set, as is the case where displaying the entire answer set would not be practical. Also, the list of records or objects displayed in the answer set may display complete or partial records or objects. The answer set may also provide a reference to the record or object or other information related to the record or object.

Another variation is that values may be entered exactly as they are to be searched, or using a range, for example, a search for ‘Date Sold’ where ‘Date Sold’ is between Jun. 1 1998 and Oct. 10 1999, or by using wild cards such as ‘Plane*’ which would return ‘Planer’, ‘Planet’, ‘Planetary’, and so forth, whereas ‘Plane?’ might returns ‘planet’, ‘planer’, and so forth.

In yet another variation, the undo search action may be unlimited in the number of steps that may be undone (until there are none remaining) or the system 100 may only be capable of undoing the previous step, but no further.

In yet another variation the step of validating the values entered, as described in the flowcharts 3, 4, 5 or 6, may include validation rules that extend beyond simple data type checking. For example, if an attribute is selected corresponding to a data type for the storage and retrieval of dates, then if the user wishes to enter a value for this attribute, the system 100 can check if the value entered is a valid date. Also, attributes may have validation rules that are specific to the attribute, for example the Price attribute may be limited to values between $10 and $100,000. In these cases, the system 100 would validate the user's values prior to permitting a search action. The selectable pulldown lists may also be defined where there exists a limited set of potential values for the selected attribute. In these cases the interface 124 can provide to the user the list of all available values for the selected attribute prior to the user selecting the value.

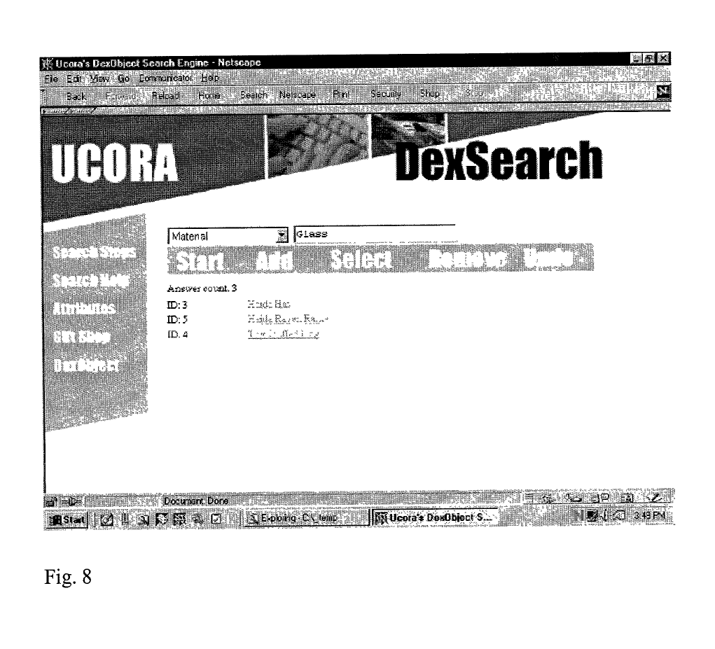

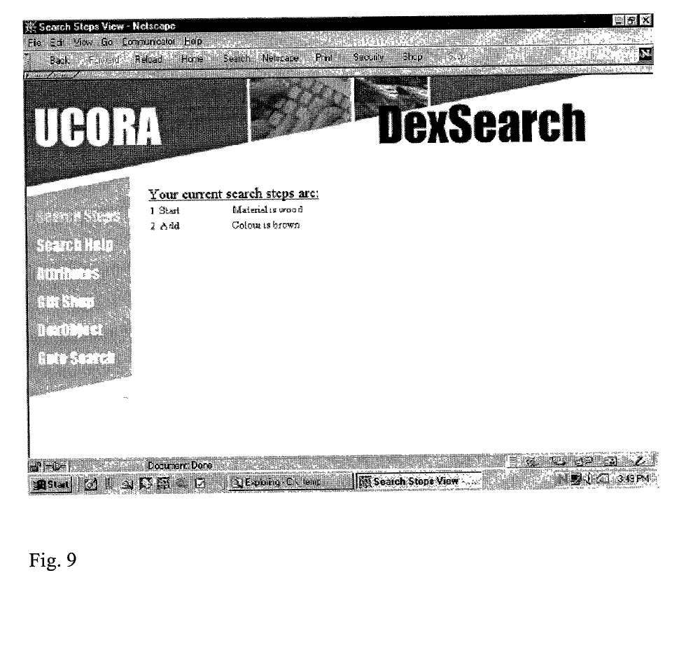

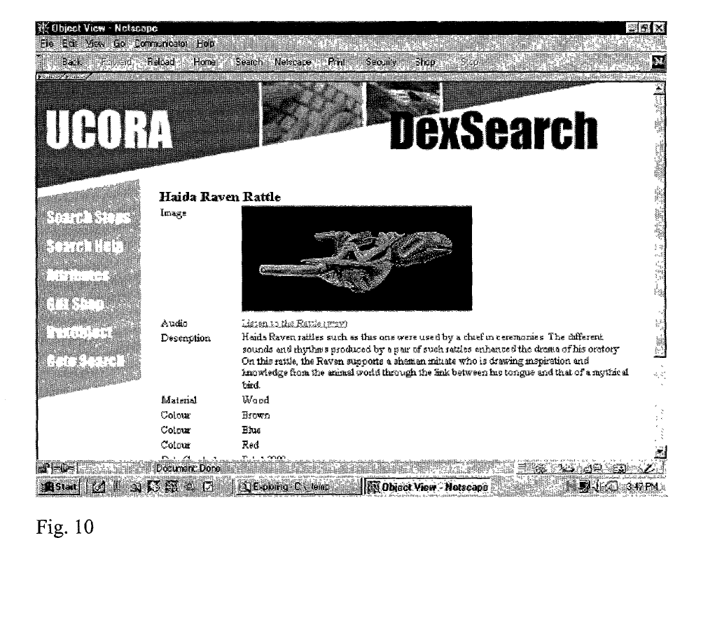

The interface 124 may be created for one of many software platforms including but not limited to Internet browser software, Windows software, Apple software, UNIX software, portable handheld software, and so forth. For example, FIGS. 8, 9 and 10 show an example of search actions and answer set displays using a web browser user interface. The same user interface 124 may be used to search multiple electronic collections by providing the user with a way of selecting a collection of records to conduct the search upon.

In yet another variation, each user of the system 100 is assigned a unique identifier and challenge response for accessing system 100. In such a variation, depending on the user's access level, the user may add attributes and corresponding attribute values to the system 100 records, such users would typically have administrative rights for the system 100.

Generally, all the actions taken by user during a search session may be logged and stored in a user session report. For example, the session report may include the administrative user's actions, such as, the attributes and values assigned to the objects and a time stamp marking the occurrence of such an event. For example, a user may optionally specify as additional criteria in a search step associated with an administrative user who assigned a particular attribute and value. For instance, a search criteria may be the following: Show all organizations where the Status is set to Active as entered by administrative user uniquely identified as John Doe or employee number: 123-456. Alternatively, the user may specify the date and time when the attribute and value were assigned, for instance: Show all organizations where the Status is set to Active as entered by John Doe between Jan. 15, 1999 and May 31, 2001 or between 1300 hours and 2100 hours.

The user may optionally specify as the only criteria in a search step the user who assigned any attribute and value and/or the date and time when the attribute was assigned. An example of such a search criteria may be: Show all organizations where any attribute was assigned by John between Jan. 1, 2000 and Feb. 1, 2001 and between 1300 hours and 2100 hours.

Also, as a further variation, the search criteria may include another operator, such as, a ‘WAS EVER’ operator which may be applied to the search step's criteria to not only the current state of the search objects, but also all historical states of the object. For example, such a search criteria may be: Find a company named ABC Co. that was initially assigned the attribute value combination City=Dallas but then had the attribute value combination changed to City=New York. The search step {City IS Dallas} would not return ABC Co., however, the search step {City WAS EVER Dallas} would return ABC Co.

The above-described embodiments of the invention are intended to be examples of the IS present invention and alterations and modifications may be effected thereto, by those of skill in the art, without departing from the scope of the invention which is defined solely by the claims appended hereto.

The embodiments of the invention in which an exclusive property or privilege is claimed are defined as follows:

1. A method of retrieving information from a collection of records, each record including at least one object having at least one attribute and a corresponding value, said method having the steps of:
defining a search criteria associated with said object and with at least one attribute and a corresponding value,
executing a plurality of search actions in accordance with a search criteria, said search actions executed progressively to produce a corresponding answer set, each subsequent search action having a different search criteria for refining said previous answer set,
displaying said answer set upon completion of a search action and recording said plurality of search actions associated with each said answer set.

2. The method of claim 1, wherein the plurality of actions includes a start action wherein said start action includes the steps of:
clearing any previous answer sets from previous search actions and any previous search action steps,
executing a search on said records in accordance with said at least one attribute including said at least one corresponding value,
displaying an answer set having records associated with said at least one attribute including said at least one corresponding value.

3. The method of claim 1, wherein the plurality of actions includes a refine action wherein said refine action includes the steps of:
executing a search on a previous result in accordance with said at least one attribute including said at least one corresponding value,
displaying a new answer set, said new answer set having records from said previous answer set result associated with said at least one attribute including said at least one corresponding value.

4. The method of claim 1, wherein the plurality of actions includes a remove search action, said method including the steps of:
executing a search action on a previous result in accordance with said at least one attribute including said at least one corresponding value,
displaying a new answer set, said new answer set having records from said previous answer set not associated with said at least one attribute including said at least one corresponding value.

5. The method of claim 1, wherein the plurality of actions includes a undo action, said method including the steps of:
reversing a last performed search action on a previous answer set, and displaying a previous answer set.

6. The method of claim 1, wherein the said attributes and answer set includes text, integers, real numbers, Boolean values, currency, dates, hyperlinks, images, sound and video.

7. The method of claim 1, wherein said at least one value includes a data-type, and each of said attributes is associated with a data-type.

8. The method of claim 7, wherein the method includes the further steps of validating said value associated with said each of said attributes.

9. The method of claim 1, wherein said displayed answer set includes a partial records matching said search criteria.

10. The method of claim 1, wherein said displayed answer set is a partial answer set matching said search criteria.

11. The method of claim 1, wherein said corresponding attribute value is a fixed value.

12. The method of claim 1, wherein said corresponding attribute value is a range of values.

13. The method of claim 1, wherein said attribute value is a specified as a wildcard select plurality of values with a single specification.

14. The method of claim 1, wherein said plurality of attributes is identified by a common title.

15. The method of claim 1, wherein said search criteria includes a comparison operator such as “IS”, “IS NOT”, “IS SPECIFIED”, “IS NOT SPECIFIED” and “WAS EVER”.

16. The method of claim 1, wherein said method includes a user interface having a selectable list of attributes, an input area for entering at least one value including a range of values, a plurality of controls associated with said search actions, a selector to select said search actions, a viewer to view said answer set and said search actions.

17. The method of claim 1, wherein the step of defining a search criteria includes a voice recognition engine for input of said search criteria and control of said search actions.

18. The method of claim 1, wherein said answer set is displayed after each search action.

19. A method of retrieving information from a database having a plurality of records, each record having objects associated with at least one attribute and a corresponding attribute value, the method having the steps of:
performing a plurality of single step query search actions,
allowing input of new search attributes and values subsequent to each of said steps,
displaying an answer set subsequent to the execution of each said steps and recording each of said steps in a list, and
allowing reversal of a last action in said recorded list to present an answer set prior to said last action.

20. A method of retrieving information from a collection of records, said method having the steps of:
(a) associating each of said records with at least one attribute having at least one corresponding value,
(b) initiating a first search action in accordance with a first search criteria by choosing said at least one attribute including said at least one corresponding value,
(c) creating a first answer set corresponding to said first search action,
(d) displaying said first answer set,
(e) initiating a second search action in accordance with a second search criteria by adding said at least one attribute including said at least one corresponding value to said answer set from step (b),
(f) creating a second answer set corresponding to said second search action,
(g) displaying said second answer set,
(h) initiating a third search action in accordance with a third search criteria by selecting said at least one attribute including said at least one corresponding value from said answer set from steps (e) or (b),
(i) creating a third answer set corresponding to said third search action,
(j) displaying said third answer set,
(k) initiating a fourth search action in accordance with a fourth search criteria by selecting said at least one attribute including said at least one corresponding value to remove from any of said answer sets from steps (b), (e) or (h),
(l) creating a fourth answer set corresponding to said third search action,
(m) displaying said fourth answer set,
(n) allowing a reversal of any action provided there is a prior action to reverse so that the answer set prior to said last action is presented,
wherein each search action is recorded and available for inspection and said search steps and search actions are characterized in being unlimited in number.

21. A system for retrieving information from a collection of records associated with at least one attribute and at least one corresponding attribute value, said system having:
a user interface for defining a search criteria associated with said records and with at least one attribute and a corresponding value, and said search criteria associated a plurality of search actions progressive execution to produce a corresponding answer set, each subsequent search action having a different search criteria for refining said previous answer set, said user interface having:
a selectable list of attributes associated with said records,
an input area for entering at least one value including a range of values associated with said attributes,
a selector for selecting said search actions and a display to display said answer set and said search actions.

22. A system for retrieving information from a collection of records associated with at least one attribute and at least one corresponding attribute value, said system having:
a computer readable medium for storing a program associated with a set of instructions for a plurality of search actions,
said computer readable medium including:
a set of instructions for performing a plurality of single step query search actions,
a set of instructions for allowing input of new search attributes and values upon completion of said search actions,
an instruction set for displaying an answer set upon completion of said search actions and an instruction set for recording said search actions as a list of steps, and
an instruction set for allowing reversal of a last search action in said recorded list to present an answer set prior to said last action.
